(19) United States
(12) Patent Application Publication
(10) Pub. No.: US 2025/0153796 A1
(43) Pub. Date: May 15, 2025

(54) BICYCLE CANOPY ASSEMBLY

(71) Applicant: The Radio Flyer Company, Chicago, IL (US)

(72) Inventors: Nicolas Sabbagh, Chicago, IL (US); Agostino LoBello, Chicago, IL (US)

(21) Appl. No.: 18/949,322

(22) Filed: Nov. 15, 2024

Related U.S. Application Data
(60) Provisional application No. 63/599,439, filed on Nov. 15, 2023.

(51) Int. Cl. B62J 17/083

(52) U.S. Cl. CPC B62J 17/083

(57) ABSTRACT

A canopy assembly for a bicycle having a canopy frame removably connected to a plurality of connection members, and a canopy cover assembly removably connected to the canopy frame. The canopy frame assembly has a first side frame and a second side frame. The connection members are operably secured to the bicycle. The first and second side frames are removably secured to the connection members. The canopy cover assembly has a top canopy secured to the first side frame and the second side frame, and a plurality of walls removably secured to the canopy frame assembly.

### CROSS-REFERENCE TO RELATED APPLICATIONS

This application claims the benefit of U.S. Provisional Patent Application No. 63/599,439 filed Nov. 15, 2023, which is expressly incorporated herein by reference and made a part hereof.

### FEDERALLY SPONSORED RESEARCH OR DEVELOPMENT

Not Applicable.

### TECHNICAL FIELD

The present subject matter relates to a canopy assembly for a bicycle, and more particularly, to a removeable canopy assembly for a bicycle.

### BACKGROUND

Canopy assemblies for bicycles are known in the art. While such products, according to the prior art, provide a number of advantages, they nevertheless have certain limitations. The present disclosure seeks to overcome certain of those limitations and other drawbacks of the prior art, and to provide new features not heretofore available. A full discussion of the features and advantages of the present disclosure is deferred to the following detailed description, which proceeds with reference to the accompanying drawings.

### SUMMARY

According to certain aspects of the present disclosure, the disclosed subject technology relates to a canopy assembly for a bicycle having a canopy frame removably connected to a plurality of connection members, and a canopy cover assembly removably connected to the canopy frame.

The disclosed technology further relates to a canopy assembly for a bicycle, comprising: a canopy frame assembly comprising: a first side frame having a front support pivotally connected with a pivot joint to a rear support, the front support having a first end opposite the pivot joint, and the rear support having a second end opposite the pivot joint; a second side frame having a front support pivotally connected with a pivot joint to a rear support, the front support having a first end opposite the pivot joint, and the rear support having a second end opposite the pivot joint; a front mounting member at the first end of each of the front supports; and, a rear mounting member at the second end of each of the rear supports; a plurality of connection members operably secured to the bicycle, wherein each of the front mounting members and the rear mounting members of the canopy frame assembly are removably secured, respectively, to one of the plurality of connection members; and, a canopy cover assembly connected to the canopy frame assembly, the canopy cover assembly comprising: a top canopy secured to the first side frame and the second side frame; a front canopy member extending away from top canopy toward the first end of the front supports and removably secured to the first side frame and the second side frame; a first side wall removably secured to the canopy assembly adjacent the first side frame; a second side wall removably secured to the canopy assembly adjacent the second side frame; and, a rear wall extending away from the top canopy toward the second end of the rear supports and removably secured to the first side frame and the second side frame.

The disclosed technology further relates to a canopy assembly for a bicycle, comprising: a canopy frame assembly comprising: a first side frame having a first end and a second end; a second side frame having a first end and a second end; a plurality of connection members operably secured to the bicycle, the first and second side frames removably secured to the plurality of connection members; and, a canopy cover assembly connected to the canopy frame assembly, the canopy cover assembly comprising a top canopy secured to the first side frame and the second side frame, and a plurality of walls removably secured to the canopy frame assembly.

The disclosed technology further relates to a canopy assembly for a bicycle, comprising: a plurality of connection members operably secured to the bicycle; a canopy frame assembly comprising: a first side frame having a first end and a second end; a second side frame having a first end and a second end; a front mounting member at the first end of the first side frame, and another front mounting member at the first end of the second side frame; and, a rear mounting member at the second end of the first side frame, and another rear mounting member at the second end of the second side frame, wherein each of the front and rear mounting members are adapted to be removably secured to one of the plurality of connection members; and, a canopy cover assembly connected to the canopy frame assembly, the canopy cover assembly comprising a top canopy secured to the first side frame and the second side frame, and a plurality of walls removably secured to the canopy frame assembly.

The disclosed technology further relates to a canopy assembly for a bicycle, wherein each of the plurality of connection members comprises two pieces that are connected together in a clam shell manner.

The disclosed technology further relates to a canopy assembly for a bicycle, wherein one of the plurality of connection members is provided at the first end of the first side frame, wherein one of the plurality of connection members is provided at the second end of the first side frame, wherein one of the plurality of connection members is provided at the first end of the second side frame, and wherein one of the plurality of connection members is provided at the second end of the second side frame.

The disclosed technology further relates to a canopy assembly for a bicycle, wherein each of the plurality of connection members has a receiver for removably securing one of the front and rear mounting members thereto.

The disclosed technology further relates to a canopy assembly for a bicycle, wherein the front canopy member has a plastic windshield.

The disclosed technology further relates to a canopy assembly for a bicycle, wherein the front canopy member has a screen.

The disclosed technology further relates to a canopy assembly for a bicycle, wherein the first side wall, second side wall and rear wall can be individually removed from the canopy cover assembly.

The disclosed technology further relates to a canopy assembly for a bicycle, wherein a zipper connects the first side wall to the top canopy, and wherein a zipper connects the second side wall to the top canopy.

The disclosed technology further relates to a canopy assembly for a bicycle, further comprising fasteners removably securing the first side wall to the first side frame and the second side wall to the second side frame.

The disclosed technology further relates to a canopy assembly for a bicycle, further comprising a rear joining member connecting the first side frame with the second side frame adjacent the pivot joints, and a front joining member connecting the first side frame with the second side frame toward the first end of the front supports.

The disclosed technology further relates to a canopy assembly for a bicycle, further comprising a joining member connecting the first side frame with the second side frame.

The disclosed technology further relates to a canopy assembly for a bicycle, further comprising a front mounting member at the first end of the first side frame, a front mounting member at the first end of the second side frame, a rear mounting member at the second end of the first side frame, and a rear mounting member at the second end of the second side frame, wherein each of the front mounting members and the rear mounting members are removably secured to one of the plurality of connection members for removably securing the first side frame and the second side frame thereto.

The disclosed technology further relates to a canopy assembly for a bicycle, wherein the first side frame comprises a front support pivotally connected with a pivot joint to a rear support, the front support having a first end opposite the pivot joint, and the rear support having a second end opposite the pivot joint, and wherein the second side frame comprises a front support pivotally connected with a pivot joint to a rear support, the front support having a first end opposite the pivot joint, and the rear support having a second end opposite the pivot joint.

The disclosed technology further relates to a canopy assembly for a bicycle, wherein the plurality of walls of the canopy frame assembly comprise a first side wall removably secured to the canopy assembly adjacent the first side frame, and a second side wall removably secured to the canopy assembly adjacent the second side frame.

The disclosed technology further relates to a canopy assembly for a bicycle, further comprising a front canopy member extending away from top canopy toward the first end of the front supports and removably secured to the first side frame and the second side frame, and a rear wall extending away from the top canopy toward the second end of the rear supports and removably secured to the first side frame and the second side frame.

The disclosed technology further relates to a canopy assembly for a bicycle, wherein each of the plurality of connection members has a receiver, and wherein the front mounting members and the rear mounting members mate with the receiver in the respective plurality of connection members to removably connect the canopy frame to the plurality of connection members.

The disclosed technology further relates to a canopy assembly for a bicycle, wherein the first side frame has a front support pivotally connected with a pivot joint to a rear support, the front support having the first end opposite the pivot joint, and the rear support having the second end opposite the pivot joint, and wherein the second side frame has a front support pivotally connected with a pivot joint to a rear support, the front support having the first end opposite the pivot joint, and the rear support having the second end opposite the pivot joint.

It is understood that other embodiments and configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

To understand the present disclosure, it will now be described by way of example, with reference to the accompanying drawings in which embodiments of the disclosures are illustrated and, together with the descriptions below are incorporated in and constitute a part of this specification, and serve to explain the principles of the disclosure. In the drawings:

FIG. 1 is a perspective view of a canopy frame assembly for a bicycle, according to the present disclosure.

FIG. 2 is a perspective view of a canopy frame for the canopy frame assembly of FIG. 1, according to the present disclosure.

FIG. 3 is a perspective view of a cargo frame assembly for bicycle that accepts the canopy frame of FIG. 2, according to the present disclosure.

FIG. 4 is a perspective view of a disassembled canopy frame assembly, according to the present disclosure.

FIG. 5 is a perspective view of the canopy frame assembly of FIG. 1, with a front canopy included, according to the present disclosure.

FIG. 6 is a perspective view of the canopy frame assembly of FIG. 6, with sides attached to the front canopy, according to the present disclosure.

FIG. 7 is another perspective view of the canopy frame assembly on a bicycle, according to the present disclosure.

FIG. 8 is a side view of the canopy frame assembly of FIG. 6, according to the present disclosure.

FIG. 9 is a rear view of the canopy frame assembly of FIG. 6, according to the present disclosure.

FIG. 10 is a perspective view of the canopy frame assembly of FIG. 6, with the cargo passenger liner included, according to the present disclosure.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

While this disclosure is susceptible of embodiments in many different forms, there is shown in the drawings and will herein be described in detail preferred embodiments with the understanding that the present disclosure is to be considered as an exemplification of the principles of the disclosure and is not intended to limit the broad aspect of the disclosure to the embodiments illustrated. It should be noted that the features illustrated in the drawings are not necessarily drawn to scale, and features of one embodiment may be employed with other embodiments as one of ordinary skill in the relevant art would recognize, even if not explicitly stated herein. Further, descriptions of well-known components and processing techniques may be omitted so as to not unnecessarily obscure the embodiments of the present disclosure. The examples used herein are intended merely to facilitate an understanding of ways in which the present disclosure may be practiced and to further enable those of ordinary skill in the art to practice the embodiments of the present disclosure. Accordingly, the examples and embodiments herein should not be construed as limiting the scope of the present disclosure, which is defined solely by the appended claims and applicable law.

Generally, this disclosure describes several embodiments of canopy frame assemblies for bicycles, and preferably canopy frame assemblies that can be easily connected and removed from a bicycle, and canopy assemblies that are arrangeable in a variety of different orientations.

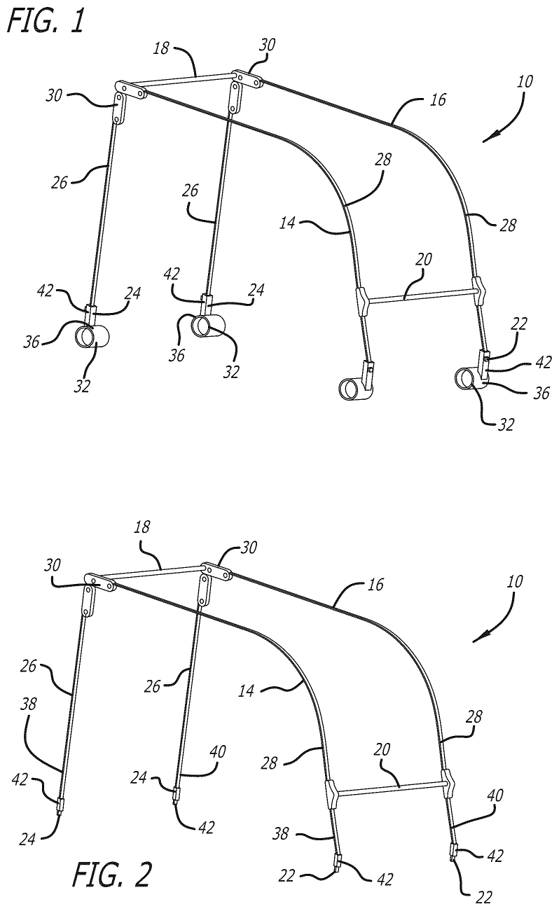

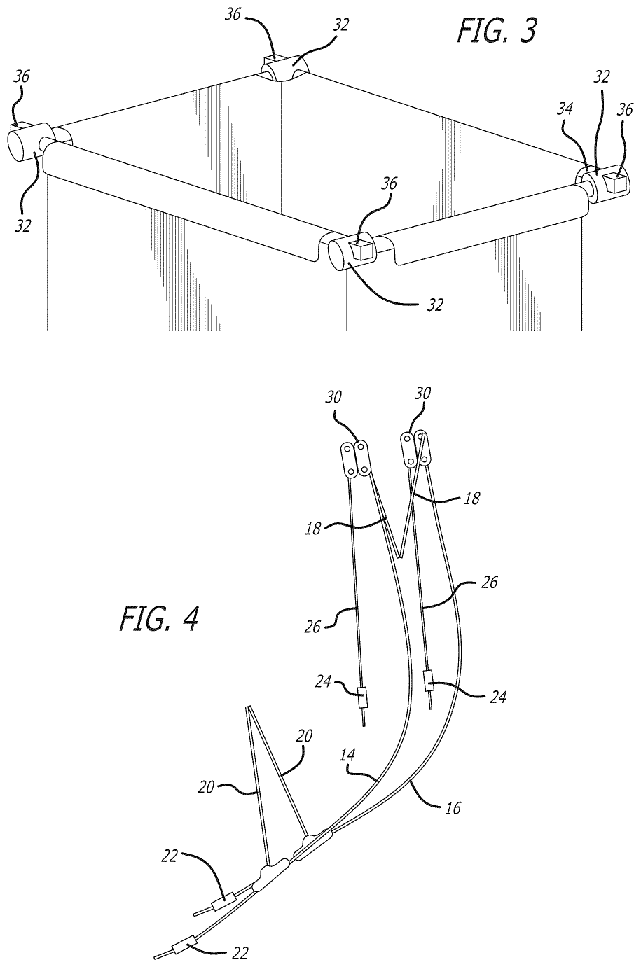

Referring now to the figures, and initially to FIGS. 1-4, there is shown a canopy assembly 11 for a bicycle, where, in one embodiment, the canopy assembly 11 comprises a canopy frame assembly 10, a plurality of connection members 32, and a canopy cover assembly 44.

In one embodiment, the canopy frame assembly 10 generally comprises a first side frame 14, a second side frame 16, a rear joining member 18, a front joining member 20, two front connectors 22, and two rear connectors 24. As best shown in FIG. 4, in one embodiment, the first side frame 14 and the second side frame 16 may each comprise a rear support 26 pivotally connected to a front support 28 with a pivot joint 30. Additionally, in one embodiment, as also shown FIG. 4, the rear joining member 18 and the front joining member 20 may each be made of multiple pieces for shipping and storage, but that join to form an integral member in the completed assembly for use. In one embodiment, the front support 28 of the first side frame 14 has first end opposite the pivot joint 30, and the rear support 26 of the first side frame 14 has a second end opposite the pivot joint 30. Further, in one embodiment, the front support 28 of the second side frame 16 has a first end opposite the pivot joint 30, and the rear support 26 of the second side frame 16 has a second end opposite the pivot joint 30. A front mounting member 42 is provided at the first end of each of the front supports 28, and, a rear mounting member 42 is provided at the second end of each of the rear supports 26.

As shown in FIGS. 1, 3 and 5, the canopy assembly 11 also includes a plurality of connection members 32 that are operably secured to the bicycle 12, and preferably to a cargo frame 34 of the bicycle 12. The connection members 32 are provided at each of the four corners of the canopy frame 10. In one embodiment the connection members 32 comprise two pieces that are connected in a clam shell manner around portions of the cargo frame 34. The two pieces of each connection member 32 may be fixedly or removably connected to one another. Each connection member 32 has a receiver 36. And, in one embodiment, the two ends 38 of the first side frame 14, and the two ends 40 of the second side frame 16, each have mounting members 42 that mate with the receivers 36 to removably connect the canopy frame 10 to the connection members 32 for securing the canopy frame 10 on the bicycle 12 as shown in FIG. 6.

In one embodiment the mounting members 42 individually clip into the receivers 36, and they can be individually removed from the receivers 36.

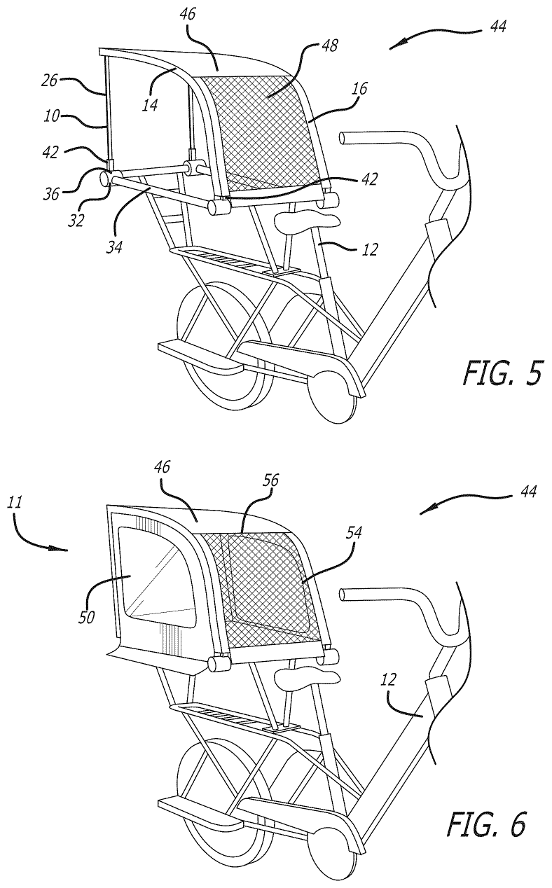

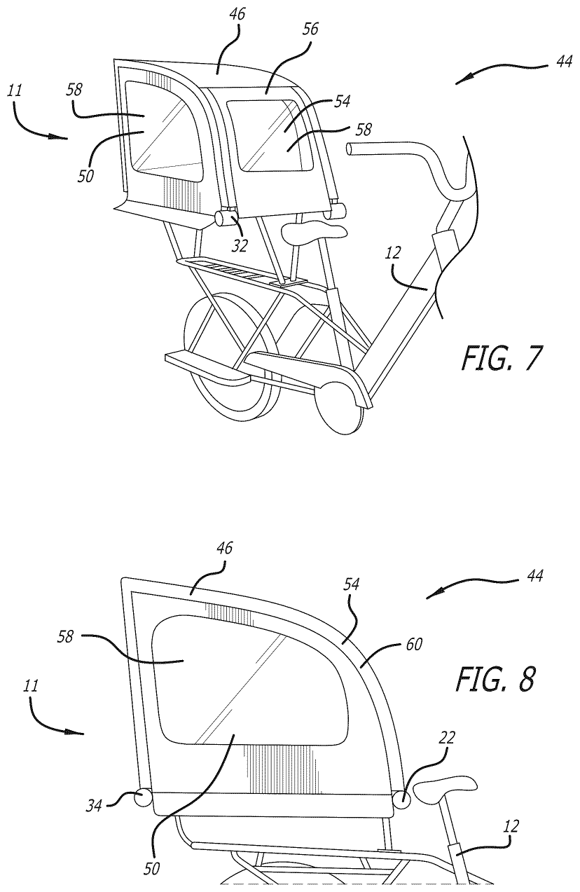

As shown in FIG. 5, in one embodiment, the overall canopy assembly 11 comprises the canopy frame 10 and a canopy cover assembly 44 that is removably secured to the canopy frame 10. In one embodiment, the canopy cover assembly 44 comprises one or more of a top canopy 46 to shield the rider from the sun. Additionally, a front canopy member 48, which may or may not have a screen component, side walls 50 and a rear wall 52 may be included. The top canopy 46 is secured to the first side frame 14 and the second side frame 16. Additionally, as shown in FIG. 7, a front plastic windshield 54 is secured within a pocket 56 on the top canopy 46, and can be rolled down over the front canopy member 48 to provide wind and rain protection for the rider. The front canopy member extends away from top canopy 46 toward the first end of the front supports 28 and removably secured to the first side frame 14 and the second side frame 16. The first side wall 50 is removably secured to the canopy assembly adjacent the first side frame 14, and the second side wall 50 is removably secured to the canopy assembly adjacent the second side frame 16. The rear wall 52 extends away from the top canopy 46 toward the second end of the rear supports 26 and is removably secured to the first side frame 14 and the second side frame 16.

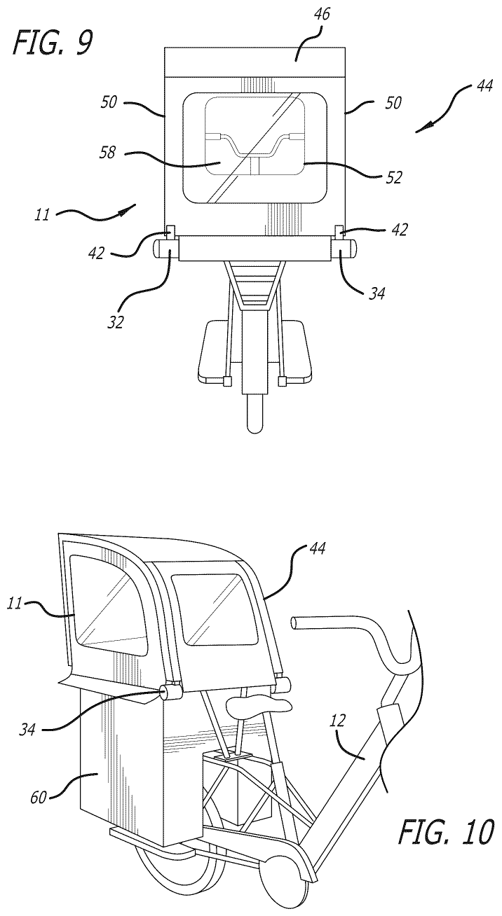

Referring to FIGS. 5-9, each of the side walls 50 and rear wall 52 can be attached or removed from the canopy cover assembly 44. The side walls 50 and rear wall 52 may have windows 58. As shown in FIGS. 5, 6 and 8, a zipper 60 connects each side wall 50 to the top canopy 46 and integral front screen component 48. Further, the side walls 50 can be secured with fasteners, such as Velcro, to the respective rear supports 26 of the first and second side frames 14 and 16. Thus, the side walls 50 can be zipped and fastened in place as shown in FIGS. 6-8, or they can be unzipped and removed as shown in FIG. 5. Similarly, the rear wall 52, as best shown in FIG. 9, can be rolled up and secured to the top canopy 46 as shown in FIG. 5. Alternately, it may be connected with a fastener, such as a zipper, to the top canopy 46 and thus can be connected or removed with the use of the zipper. In the use or down position, the rear wall 52 is preferably fastened, such as with Velcro fasteners, to the respective rear supports 26 of the first and second side frames 14 and 16, as shown in FIG. 9.

As shown in FIG. 10, the canopy assembly 11 can be used with a passenger liner 60 that is also connected to the cargo frame 34.

In one embodiment, the various components of the canopy cover assembly 44 comprise a combination of soft sided fabric material, screen material, and plastic or vinyl material for the windows. Further, the overall canopy assembly 11 can be connected to and removed from the connection members 32 with the canopy frame 10 assembled and with the canopy cover assembly 44 secured to the canopy frame 10.

The embodiments detailed hereinabove may be combined in full or in part, with any alternative embodiments described.

A reference to an element in the singular is not intended to mean “one and only one” unless specifically stated, but rather “one or more.” The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

Numerous modifications to the present disclosure will be apparent to those skilled in the art in view of the foregoing description. Preferred embodiments of this disclosure are described herein, including the best mode known to the inventors for carrying out the disclosure. It should be understood that the illustrated embodiments are exemplary only, and should not be taken as limiting the scope of the disclosure.

Several alternative embodiments and examples have been described and illustrated herein. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. Additionally, the terms “first,” “second,” “third,” and “fourth” as used herein are intended for illustrative purposes only and do not limit the embodiments in any way. Further, the term “plurality” as used herein indicates any number greater than one, either disjunctively or conjunctively, as necessary, up to an infinite number. Additionally, the term “having” as used herein in both the disclosure and claims, is utilized in an open-ended manner.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the term “include,” “have,” or the like is used in the description or the claims, such term is intended to be inclusive in a manner similar to the term “comprise” as “comprise” is interpreted when employed as a transitional word in a claim. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No claim element is to be construed under the provisions of 35 U.S.C. § 112, sixth paragraph, unless the element is expressly recited using the phrase “means for” or, in the case of a method claim, the element is recited using the phrase “step for.”

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

It will be understood that the present disclosure may be embodied in other specific forms without departing from the spirit or central characteristics thereof. The present examples and embodiments, therefore, are to be considered in all respects as illustrative and not restrictive, and the Claims are not to be limited to the details given herein. Accordingly, while the specific embodiments have been illustrated and described, numerous modifications come to mind without significantly departing from the spirit of the disclosure and the scope of protection is only limited by the scope of the accompanying Claims.

Further, the claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A canopy assembly for a bicycle, comprising:
a canopy frame assembly comprising:
a first side frame having a front support pivotally connected with a pivot joint to a rear support, the front support having a first end opposite the pivot joint, and the rear support having a second end opposite the pivot joint;
a second side frame having a front support pivotally connected with a pivot joint to a rear support, the front support having a first end opposite the pivot joint, and the rear support having a second end opposite the pivot joint;
a front mounting member at the first end of each of the front supports; and,
a rear mounting member at the second end of each of the rear supports;
a plurality of connection members operably secured to the bicycle, wherein each of the front mounting members and the rear mounting members of the canopy frame assembly are removably secured, respectively, to one of the plurality of connection members; and,
a canopy cover assembly connected to the canopy frame assembly, the canopy cover assembly comprising:
a top canopy secured to the first side frame and the second side frame;
a front canopy member extending away from top canopy toward the first end of the front supports and removably secured to the first side frame and the second side frame;
a first side wall removably secured to the canopy assembly adjacent the first side frame;
a second side wall removably secured to the canopy assembly adjacent the second side frame; and,
a rear wall extending away from the top canopy toward the second end of the rear supports and removably secured to the first side frame and the second side frame.

2. The canopy assembly of claim 1, wherein each of the plurality of connection members comprises two pieces that are connected together in a clam shell manner.

3. The canopy assembly of claim 1, wherein one of the plurality of connection members is provided at the first end of the first side frame, wherein one of the plurality of connection members is provided at the second end of the first side frame, wherein one of the plurality of connection members is provided at the first end of the second side frame, and wherein one of the plurality of connection members is provided at the second end of the second side frame.

4. The canopy assembly of claim 1, wherein each of the plurality of connection members has a receiver for removably securing one of the front and rear mounting members thereto.

5. The canopy assembly of claim 1, wherein the front canopy member has a plastic windshield.

6. The canopy assembly of claim 1, wherein the front canopy member has a screen.

7. The canopy assembly of claim 1, wherein the first side wall, second side wall and rear wall can be individually removed from the canopy cover assembly.

8. The canopy assembly of claim 7, wherein a zipper connects the first side wall to the top canopy, and wherein a zipper connects the second side wall to the top canopy.

9. The canopy assembly of claim 1, further comprising fasteners removably securing the first side wall to the first side frame and the second side wall to the second side frame.

10. The canopy assembly of claim 1, further comprising a rear joining member connecting the first side frame with the second side frame adjacent the pivot joints, and a front joining member connecting the first side frame with the second side frame toward the first end of the front supports.

11. A canopy assembly for a bicycle, comprising:
a canopy frame assembly comprising:
a first side frame having a first end and a second end;
a second side frame having a first end and a second end;
a plurality of connection members operably secured to the bicycle, the first and second side frames removably secured to the plurality of connection members; and,
a canopy cover assembly connected to the canopy frame assembly, the canopy cover assembly comprising a top canopy secured to the first side frame and the second side frame, and a plurality of walls removably secured to the canopy frame assembly.

12. The canopy assembly of claim 11, further comprising a joining member connecting the first side frame with the second side frame.

13. The canopy assembly of claim 11, further comprising a front mounting member at the first end of the first side frame, a front mounting member at the first end of the second side frame, a rear mounting member at the second end of the first side frame, and a rear mounting member at the second end of the second side frame, wherein each of the front mounting members and the rear mounting members are removably secured to one of the plurality of connection members for removably securing the first side frame and the second side frame thereto.

14. The canopy assembly of claim 11, wherein the first side frame comprises a front support pivotally connected with a pivot joint to a rear support, the front support having a first end opposite the pivot joint, and the rear support having a second end opposite the pivot joint, and wherein the second side frame comprises a front support pivotally connected with a pivot joint to a rear support, the front support having a first end opposite the pivot joint, and the rear support having a second end opposite the pivot joint.

15. The canopy assembly of claim 11, wherein the plurality of walls of the canopy frame assembly comprise a first side wall removably secured to the canopy assembly adjacent the first side frame, and a second side wall removably secured to the canopy assembly adjacent the second side frame.

16. The canopy assembly of claim 15, further comprising a front canopy member extending away from top canopy toward the first end of the front supports and removably secured to the first side frame and the second side frame, and a rear wall extending away from the top canopy toward the second end of the rear supports and removably secured to the first side frame and the second side frame.

17. A canopy assembly for a bicycle, comprising:
a plurality of connection members operably secured to the bicycle;
a canopy frame assembly comprising:
a first side frame having a first end and a second end;
a second side frame having a first end and a second end;
a front mounting member at the first end of the first side frame, and another front mounting member at the first end of the second side frame; and,
a rear mounting member at the second end of the first side frame, and another rear mounting member at the second end of the second side frame, wherein each of the front and rear mounting members are adapted to be removably secured to one of the plurality of connection members; and,
a canopy cover assembly connected to the canopy frame assembly, the canopy cover assembly comprising a top canopy secured to the first side frame and the second side frame, and a plurality of walls removably secured to the canopy frame assembly.

18. The canopy assembly of claim 17, wherein each of the plurality of connection members has a receiver, and wherein the front mounting members and the rear mounting members mate with the receiver in the respective plurality of connection members to removably connect the canopy frame to the plurality of connection members.

19. The canopy assembly of claim 17, wherein the first side frame has a front support pivotally connected with a pivot joint to a rear support, the front support having the first end opposite the pivot joint, and the rear support having the second end opposite the pivot joint, and wherein the second side frame has a front support pivotally connected with a pivot joint to a rear support, the front support having the first end opposite the pivot joint, and the rear support having the second end opposite the pivot joint.

20. The canopy assembly of claim 17, wherein the plurality of walls of the canopy frame assembly comprise a first side wall removably secured to the canopy assembly adjacent the first side frame, and a second side wall removably secured to the canopy assembly adjacent the second side frame.
